(19) United States
(12) Patent Application Publication
(10) Pub. No.: US 2022/0155607 A1
(43) Pub. Date: May 19, 2022

(54) POLARISATION SEPARATION DEVICE, DIFFERENTIAL INTERFEROMETER AND DIFFERENTIAL OPTICAL CONTRAST MICROSCOPE COMPRISING SUCH A DEVICE

(71) Applicant: HORIBA FRANCE SAS, Palaiseau (FR)

(72) Inventors: Olivier ACHER, GIF-SUR-YVETTE (FR); Simon RICHARD, PALAISEAU (FR)

(21) Appl. No.: 17/438,763

(22) PCT Filed: Mar. 11, 2020
(86) PCT No.: PCT/FR2020/050500

§ 371 Date: Sep. 13, 2021

(30) Foreign Application Priority Data
Mar. 14, 2019 (FR) 1902638

(51) Int. Cl. G02B 27/28; G02B 7/02; G02B 26/06

(52) U.S. Cl. CPC G02B 27/283; G02B 5/3083; G02B 26/06; G02B 7/021

(57) ABSTRACT

Disclosed is a polarization separation device to receive an incident light beam. The device includes first and second geometric-phase lenses, having respective first optical centers, first optical axes and first focal lengths. The first and second geometric-phase lenses are separated from one another by a first distance according to the first optical axis, the first geometric-phase lens and the second geometric-phase lens being disposed to have an optical power with the same sign for a first circular polarization state and an optical power with an opposite sign for another circular polarization state orthogonal to the first circular polarization state. The device is configured and directed so a projection of the first optical center according to the first optical axis on the second geometric-phase optical lens is located at a non-zero second distance from the second optical center.

### BACKGROUND OF THE INVENTION

### Field of the Invention

The present invention generally relates to the field of polarization separation optical components.

More particularly, it relates to a polarization separation device as well as a differential interferometer and a differential contrast microscope comprising such a device.

### Description of the Related Art

Polarization separation devices are optical components that allow separating an incident light beam into two polarized components according to different polarization states.

For example, known polarization separation device include Rochon prisms and Wollaston prisms. They are based on the use of two prisms made of birefringent materials. These prisms separate an incident light beam into two emergent light beams each having a linear polarization and the polarizations of the two emergent light beams are orthogonal. The angle between the two emergent light beams depends on the birefringence properties of the materials forming the prisms, the orientation of the birefringence axes with respect to the faces of the prisms and the angles of the prisms.

Nomarski prisms are a variant of Wollaston prisms. They allow obtaining an angular separation of the incident light beam into two linear polarizations but also spatially defining the intersection point of two emergent light beams polarized orthogonally to one another.

Polarization separation cubes (also called “MacNeille cubes”) are another type of polarization separation devices. They include two prisms made of isotropic materials connected by their hypotenuse. The hypotenuse comprises a coating which has reflection and transmission properties dependent on the incident polarization.

However, for all these polarization separation devices, the separation angle of the emergent light beams is given by construction. Once the component is manufactured, it is not possible to adjust this separation angle. In addition, these components based on prisms have a significant thickness as they involve a surface that is oblique with respect to the incident light beam. Since the section of these components based on prisms is limited, the section of the emergent light beams also has a limited size. Finally, at the output of these components, the emergent light beams have linear polarizations.

### SUMMARY OF THE INVENTION

In order to overcome these aforementioned drawbacks of the state of the art, the present invention provides a thin polarization separation device whose separation angle is easily adjustable.

More particularly, according to the invention, a polarization separation device intended to receive an incident light beam is provided. According to the invention, the device comprises a first geometric-phase lens, having a first optical center, a first optical axis and a positive first focal length for a first circular polarization state and an opposite focal length for another circular polarization state orthogonal to the first circular polarization state, and a second geometric-phase lens, having a second optical center, a second optical axis and a positive second focal length for the first circular polarization state and an opposite focal length for the other circular polarization state, the first optical axis and the second optical axis forming an angle smaller than a few degrees, the first and second geometric-phase lenses being separated from one another by a first distance according to the first optical axis. According to the invention, the device is configured and directed so that a projection of the first optical center according to the first optical axis on the second geometric-phase optical lens is located at a non-zero second distance from the second optical center, said first distance being smaller than said first focal length and said second focal length.

Thus, according to the invention, a transverse offset is introduced between the first optical center of the first geometric-phase lens and the second optical center of the second geometric-phase lens. By their properties, the two geometric-phase lenses allow separating the two right and left circular polarization components of a light beam. By construction, these two components are diverted, at the output of the device in accordance with the invention, by a determined separation angle which will depend on the transverse offset between the two optical centers. Thanks to the invention, this offset is adjustable, therefore allowing adjusting the separation angle between the two beams corresponding to the two circular polarization components, by displacing the second geometric-phase lens transversely to the optical axis. According to the invention, the combination of two geometric-phase lenses is therefore advantageous to allow adjusting the separation angle of the polarizations at the output of the device. In addition, the small thickness of the geometric-phase lenses allows obtaining a thin device.

Other non-limiting and advantageous features of the polarization separation device in accordance with the invention, considered separately or according to any technically-feasible combination, are as follows:
the first focal length and the second focal length have a difference less than or equal to 10%;
the second optical axis is offset by the second distance with respect to the first optical axis;
a translational means between the first and second geometric-phase lenses is provided, said translational means being adapted to offset the second optical center with respect to the first optical center according to a direction transverse to the first optical axis;
the first optical axis forms an angle with respect to an axis of propagation of the incident light beam on said device;
a means for rotating the first and second geometric-phase lenses is provided, the first geometric-phase lens and the second geometric-phase lens being held parallel to one another, said rotational means being adapted to simultaneously incline said first and second geometric-phase lenses with respect to the incident light beam;
the first distance is smaller than 20% of the first focal length and of the second focal length;
the first geometric-phase lens and/or the second geometric-phase lens have a spherical or cylindrical optical power;
a divergent optical lens is provided;
a quarter-wave delay plate is provided; and
a third geometric-phase lens is provided, having a third optical center, a third optical axis and a third focal length, and a fourth geometric-phase lens, having a fourth optical center, a fourth optical axis and a fourth focal length, the third geometric-phase lens and the fourth geometric-phase lens being disposed so as to have an optical power with the same sign for the first circular polarization state and with an opposite sign for the other circular polarization state, the third optical axis and the fourth optical axis forming an angle smaller than a few degrees with the first optical axis, the third and fourth geometric-phase lenses being separated from one another by a third distance according to the third optical axis, a projection of the third optical center according to the third optical axis on the fourth geometric-phase lens being located at a non-zero fourth distance from the fourth optical center, said third distance being smaller than said third focal length and said fourth focal length.

The invention also provides a differential interferometer comprising a polarization separation device as described before.

The invention also provides a differential contrast optical microscope comprising a polarization separation device as described before.

### BRIEF DESCRIPTION OF THE DRAWINGS

The following description with reference to the appended drawings, provided as non-limiting examples, will set out the object of the invention and the manner in which it could be carried out.

In the appended drawings:

FIG. 1 is a schematic representation of the different elements of a polarization separation device in accordance with the invention,

FIG. 2 is a schematic representation of a first example of a polarization separation device in accordance with the invention,

FIG. 3 is a schematic representation of a second example of a polarization separation device in accordance with the invention,

FIG. 4 is a schematic representation of a variant of the first or second polarization separation device in accordance with the invention,

FIG. 5 is a schematic representation of another example of a polarization separation device in accordance with the invention,

FIG. 6 is a schematic representation of a first example of a differential interferometry system comprising a polarization separation device in accordance with the invention,

FIG. 7 is a schematic representation of a second example of a differential interferometry system comprising a polarization separation device in accordance with the invention, and

FIG. 8 is a schematic representation of a polarization separation device in accordance with the invention intended for example to be integrated in a differential contrast microscope.

### DESCRIPTION OF THE PREFERRED EMBODIMENTS

The present invention relates to a polarization separation device 1 (also called device 1 later on).

In this description, an optical component called “geometric-phase lens” is introduced. A geometric-phase lens is made from geometric-phase holograms and/or liquid crystals. Making of geometric-phase lenses is described in the document Optimisation of aspheric geometric-phase lenses for improved field-of-view, Kathryn J. Hornburg et al. (SPIE Optical Engineering and Applications, Proceedings Volume 10743, Optical Modeling and Performance Predictions X; 1074305, 2018).

A geometric-phase lens is manufactured from liquid crystals. A different phase is defined at each point of the component from the orientation layout of the liquid crystals.

As regards the operation of these components, a light beam crossing one of these geometric-phase lenses is considered. As it is known, the light beam may be decomposed into a right circular polarization component and a left circular polarization component. By its design, for one of the circular polarizations (for example the right circular polarization), the geometric-phase lens behaves like a convergent lens with a focal length +f. For the other polarization (herein the left circular polarization), the geometric-phase lens behaves like a divergent lens with a focal length −f. In other words, a geometric-phase lens has a positive optical power for a circular polarization and a negative optical power for the other circular polarization. In addition, upon crossing the geometric-phase lens, the right circular polarization state is transformed into a left circular polarization and vice versa.

One single geometric-phase lens does not allow spatially separating the two orthogonal circular polarizations. In general, a geometric-phase lens operates for a given wavelength range, for example comprised between 450 and 600 nm.

For example, the geometric-phase lenses used in the invention are of the type of the components commercialized under the name “polarization directed flat lenses” by the company Edmund Optics or the company ImagineOptix.

In practice, a geometric-phase lens has a flat aspect that is to say without any physical radius of curvature. The thickness of a geometric-phase lens is small, typically in the range of 0.4 millimeters (mm). The diameter of a geometric-phase lens is typically in the range of 25 mm. For example, the surface area of a geometric-phase lens is 120×120 mm².

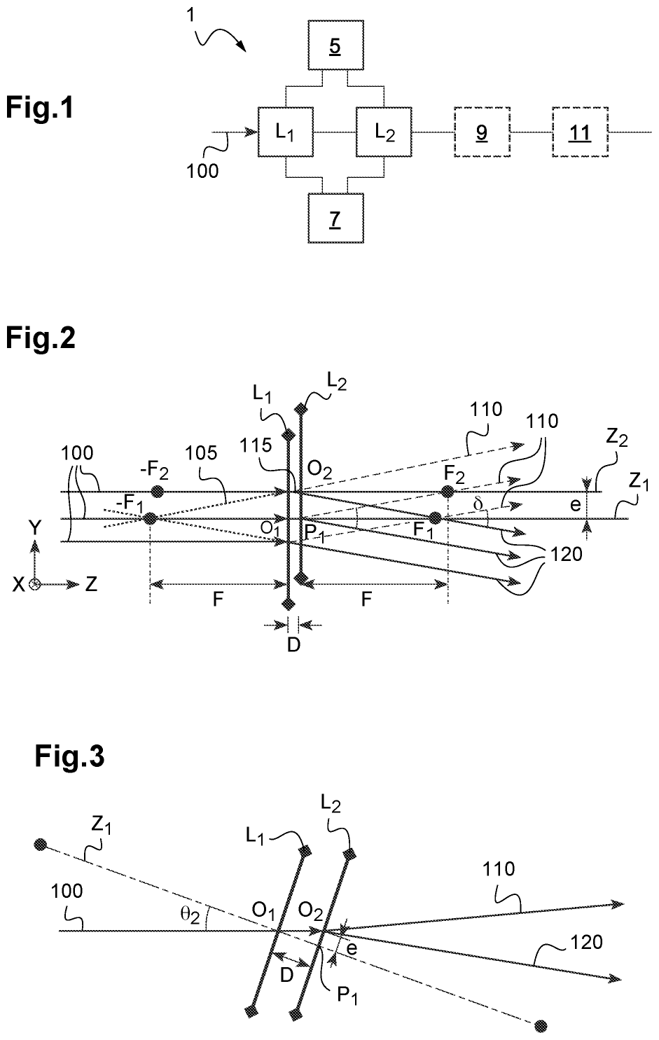

FIG. 1 represents the different elements of a polarization separation device 1 in accordance with the invention intended to receive an incident light beam 100. In general, this incident light beam 100 is collimated. Alternatively, the incident light beam 100 is not collimated at the input of the device 1.

The device 1 comprises a first geometric-phase lens L₁ and a second geometric-phase lens L₂. Optionally, the device 1 comprises a translational means 5 between the first geometric-phase lens L₁ and the second geometric-phase lens L₂ and/or a means 7 for rotating the first geometric-phase lens L₁ and the second geometric-phase lens L₂, a lens 9 and/or a quarter-wave delay plate 11.

As shown in FIGS. 2 to 4, the first geometric-phase lens L₁ has a first optical center O₁, a first optical axis Z₁ and a first focal length F₁. The first optical axis Z₁ is orthogonal to the flat faces of the first geometric-phase lens L₁ and passes through the first optical center O₁. The second geometric-phase lens L₂ has a second optical center O₂, a second optical axis Z₂ and a second focal length F₂. The second optical axis Z₂ is orthogonal to the flat faces of the second geometric-phase lens L₂ and passes through the second optical center O₂. Preferably, the first focal length F₁ and the second focal length F₂ are equal to a focal length F to keep the beams collimated. The device also operates if the first focal length F₁ and the second focal length F₂ are different but close, for example by a difference less than or equal to 10%.

Herein, the first geometric-phase lens L₁ and the second geometric-phase lens L₂ have a spherical optical power. The first geometric-phase lens L₁ and the second geometric-phase lens L₂ are convergent for a circular polarization and divergent for the other circular polarization. In this case, the first geometric-phase lens L₁ and the second geometric-phase lens L₂ respectively focus at the focal points F₁ and −F₁ on the first optical axis Z₁ and at the focal points F₂ and −F₂ on the second optical axis Z₂. Alternatively, the first geometric-phase lens L₁ and the second geometric-phase lens L₂ have a cylindrical optical power, while being convergent for a circular polarization and divergent for the other circular polarization. In the case of a lens having a cylindrical optical power, for example in the case where the first geometric-phase lens L₁ has a cylindrical optical power, a collimated incident light beam with an axis parallel to the first optical axis Z₁ is focused according to a line segment orthogonal to the first optical axis Z₁ passing through the focal point F₁ for a circular polarization and according to another line segment orthogonal to the first optical axis Z₁ passing through the focal point −F₁ for the other circular polarization. Whether they have a spherical or cylindrical optical power, these geometric-phase lenses have different geometric aberrations, in the same manner as spherical or cylindrical conventional lenses could be while being referred to as aspherical or acylindrical lens. Depending on their design, the geometric-phase lenses may have lesser geometric aberrations. The geometric-phase lenses may also be corrected for chromatic aberrations over a predetermined spectral band.

The first geometric-phase lens L₁ and the second geometric-phase lens L₂ are positioned in the same direction.

The first geometric-phase lens L₁ and the second geometric-phase lens L₂ are in contact or separated from one another by a first distance D according to the first optical axis Z₁. In practice, this first distance D is smaller than the first focal length F₁ and the second focal length F₂. For example, the first distance D is smaller than 20% of the first focal length F₁ and of the second focal length F₂. Preferably, the first distance D is for example smaller than 10% of the first focal length F₁ and of the second focal length F₂. In other words, the first distance D is as small as possible. In the case where the first focal length F₁ and the second focal length F₂ are equal to the focal length F, the first distance D is smaller than the focal length F, in practice smaller than 20% of the focal length F. Preferably, the first distance D is smaller than 10% of the focal length F. Preferably, the first distance D is non-zero in order to avoid the formation of interferences between the first geometric-phase lens L₁ and the second geometric-phase lens L₂. In FIG. 2, the first distance D is for example in the range of 0.5 mm.

In general, the first optical axis Z₁ and the second optical axis Z₂ form an angle smaller than a few degrees. In the following, the first optical axis Z₁ and the second optical axis Z₂ are for example parallel.

The device 1 is configured so that the second optical center O₂ is offset by a second distance e with respect to a projection P1 of the first optical center O₁ on the second geometric-phase lens L₂ according to the first optical axis Z₁, transversely to an axis Z as defined by the orthonormal reference frame XYZ represented in FIGS. 2 to 4 (the second distance e is therefore fixed in this case).

For example, the second distance e may be fixed upon manufacture of the device 1.

Optionally, the device 1 further comprises the translational means 5 between the first geometric-phase lens L₁ and the second geometric-phase lens L₂. The translational means 5 is adapted to adjust the second distance e according to a direction transverse to the first optical axis Z₁ (and for example also to the second optical axis Z₂ in the case where the first optical axis Z₁ and the second optical axis Z₂ in the case where the first optical axis Z₁ and the second optical axis Z₂ are parallel). In practice, the translational means 5 is therefore adapted to offset the second geometric-phase lens L₂ by the second distance e according to a direction transverse to the first optical axis Z₁. In this example, the projection P₁ of the first optical center O₁ according to the first optical axis Z₁ on the second geometric-phase lens L₂ is located at the second distance e from the second optical center O₂. In this instance, the second distance e is for example in the range of 5 mm.

Optionally, the device 1 comprises a so-called compensation lens (whose function is explained hereinafter). For example, this lens 9 is a divergent conventional lens. As represented in FIG. 5, the lens 9 is positioned after the first geometric-phase lens L₁ and the second geometric-phase lens L₂. Alternatively, the lens 9 may be positioned at the input of the device 1.

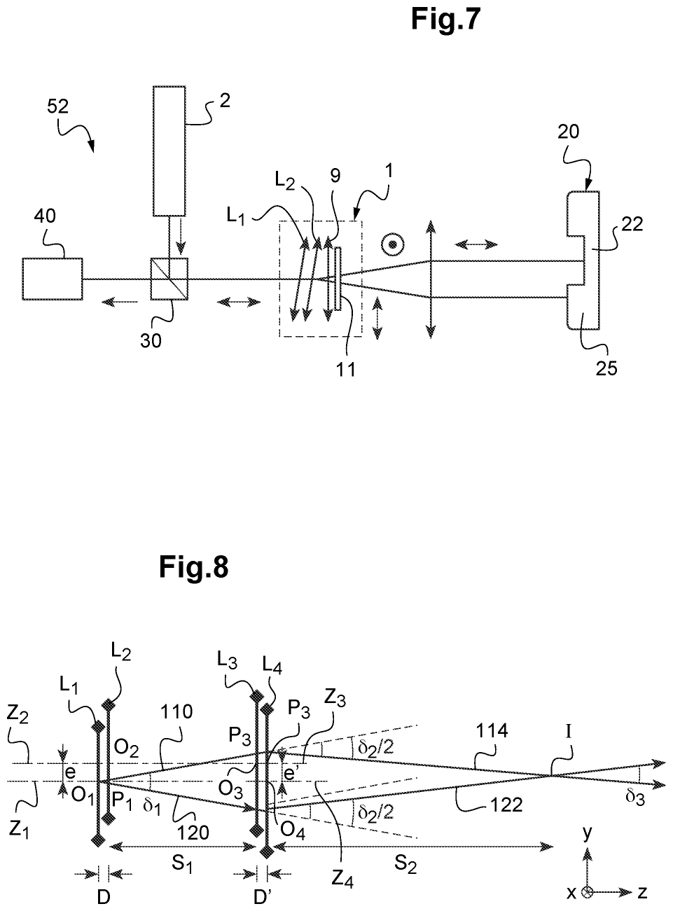

Still optionally, the device 1 comprises a quarter-wave delay plate 11. As represented in FIGS. 6 and 7, the quarter-wave delay plate 11 is positioned after the first geometric-phase lens L₁ and the second geometric-phase lens L₂, herein after the compensation lens 9.

FIG. 2 represents a first embodiment of the polarization separation device 1 in accordance with the invention. Preferably, the first geometric-phase lens L₁ and the second geometric-phase lens L₂ have the same focal length F. For example, the focal length F is comprised between 40 and 100 mm, typically in the range of 50 mm.

Herein, the first geometric-phase lens L₁ and the second geometric-phase lens L₂ are placed in contact or proximate to one another. Hence, the first distance D between the first geometric-phase lens L₁ and the second geometric-phase lens L₂ is small in comparison with the focal length F. For example, the first distance D is in the range of 3 mm.

In this first embodiment, the direction of propagation of the incident light beam 100 is parallel to the first optical axis Z₁ and to the second optical axis Z₂.

According to this first embodiment, the second optical center O₂ is offset by the second distance e with respect to the first optical axis Z₁ in a direction transverse to the axis of propagation of the incident light beam 100 which is parallel to the first optical axis Z₁ and to the second optical axis Z₂. The second distance e is comprised between 100 μm and a few millimeters.

As shown for example in FIG. 2, thanks to the translational means or by construction in the case where the second distance e is fixed by construction, the second optical axis Z₂ is offset by the second distance e with respect to the first optical axis Z₁. An offset direction of the second optical axis Z₂ with respect to the first optical axis Z₁ is also defined from the position of the second optical center O₂ with respect to the first optical axis Z₁ in the orthonormal reference frame XYZ. For example, the offset direction is defined from the position of the second optical center O₂ in the plane XY orthogonal to the axis Z. Alternatively, the offset direction may be defined from the position of the second optical center O₂ with respect to the axis of propagation of the incident light beam 100.

In practice, when considering for example the right circular polarization component of the incident light beam 100, by its operation and its orientation, the first geometric-phase lens L₁ behaves for example like a convergent lens with a focal length F. In turn, the second geometric-phase lens L₂ is directed so as to behave like a divergent lens with a focal length −F for a left circular incident polarization. In other words, the first geometric-phase lens L₁ and the second geometric-phase lens L₂ are disposed so as to have an optical power with the same sign for a first circular polarization state and an optical power with an opposite sign for the other circular polarization state orthogonal to the first circular polarization state.

At the output of the first geometric-phase lens L₁, the right circular polarization component of the incident light beam 100 is transformed into a first intermediate light beam 115 with a left circular polarization by the properties of the first geometric-phase lens L₁. The first intermediate light beam 115 is focused in the plane of the focal point F₁. Since the focal point F₁ is close to the focal point F₂ of the second geometric-phase lens L₂, the latter forms a second polarized light beam 120 which is generally collimated. Because of the presence of the offset by the second distance e between the focal point F₁ and the focal point F₂, the second polarized light beam 120 is angularly diverted according to the axis O₂F₁. Hence, this first intermediate light beam 115 is transformed into the second polarized light beam 120, which has a right circular polarization by the properties of the second geometric-phase lens L₂.

The laws of geometrical optics allow plotting the evolution of the right circular polarization component of the incident light beam 100 so as to obtain the second polarized light beam 120 with a right circular polarization. The pathway of the right circular polarization component is represented in solid line in FIG. 2.

Symmetrically, when considering the left circular polarization component of the incident light beam 100, the first geometric-phase lens L₁ behaves like a divergent lens with a focal length −F. In turn, the second geometric-phase lens L₂ behaves like a convergent lens with a focal length F.

At the output of the first geometric-phase lens L₁, the left circular polarization component of the incident light beam 100 is transformed into a second intermediate light beam 105 with a right circular polarization by the properties of the first geometric-phase lens L₁ focused in the plane of the focal point −F₁. Afterwards, this second intermediate light beam 105 is transformed into the first polarized light beam 110, which features a left circular polarization by the properties of the second geometric-phase lens L₂. The second intermediate light beam 105 is focused in the plane of the focal point −F₁. Since the focal point −F₁ is close to the focal point −F₂ of the second geometric-phase lens L₂, the latter forms a first polarized light beam 110 which is generally collimated. Because of the presence of the offset by the second distance e between the focal point −F₁ and the focal point −F₂, the first polarized light beam 110 is angularly diverted according to the axis −F₁O₂ in the plane YZ. The deflection angle [symbol] is in the range of e/F.

The laws of geometrical optics allow plotting the evolution of the left circular component so as to obtain the first polarized light beam 110 with a left circular polarization. The pathway of the left circular polarization component is represented in dotted line in FIG. 2.

As shown in FIG. 2, advantageously according to the invention, the incident light beam 100 is angularly separated into a first polarized light beam 110 and into a second polarized light beam 120. Advantageously according to the invention, the first polarized light beam 110 and the second polarized light beam 120 have orthogonal polarizations. Herein for example, the first polarized light beam 110 has a left circular polarization and the second polarized light beam 120 has a right circular polarization. A separation angle δ is defined between the first polarized light beam 110 and the second polarized light beam 120. This separation angle δ depends on the second distance e and on the focal length F. For the first distance D that is too small in comparison with the focal length F and the second distance e that is too small in comparison with the focal length F, the separation angle δ is approximately given by the relationship:

$$δ = \frac{2 e}{F} \qquad [ Math . 1 ]$$

According to the invention, the separation plane of the right circular polarization and of the left circular polarization of the incident light beam 100 is parallel to the axis of propagation of the incident light beam 100 and to the line connecting the first optical center O₁ and the second optical center O₂.

In the example of a focal length F in the range of 50 mm, the angular separation law then outputs an offset δ/e between the two polarized light beams in the range of 40 mrad/mm (or 2.3 deg/mm).

Hence, the separation angle δ is adjustable by changing the second distance e between the first optical center O₁ and the second optical center O₂. In practice, the separation angle δ is adjustable by displacing the second geometric-phase lens L₂ so as to modify the second distance e. According to the invention, the combination of two geometric-phase lenses is advantageous to allow adjusting the separation angle of the polarizations at the output of the device 1 in contrast with the known polarization separators which have a fixed separation angle. The orientation of the second distance e in the plane XY with respect to the relative positions of the first geometric-phase lens L₁ and of the second geometric-phase lens L₂ also allows directing the separation plane of the polarized light beams 110, 120. In practice, the separation of the polarized light beams 110, 120 is observed in the plane containing the first optical axis Z₁ and the second optical axis Z₂. In addition, the polarization separation device 1 is thin thanks to the small bulk of the geometric-phase lenses. For example, the thickness of the device 1 is smaller than 1.5 mm, typically in the range of 1.3 mm (versus about 20 mm for the known devices).

The device 1 in accordance with the invention is adapted to manipulate large-section light beams, which is useful for imaging applications, without the thickness bulk being increased. For example, a polarization separation device in accordance with the invention comprising two geometric-phase lenses with a 25 mm diameter and with a 0.4 mm thickness placed at 0.5 mm and with a 5 mm offset of the optical axes, and therefore with a 1.3 mm overall thickness, allows performing a polarization separation of a 20 mm diameter beam. In general, the known polarization separators allowing processing this kind of light beams have a thickness in the range of 20 mm.

FIG. 3 represents a second embodiment of the polarization separation device 1 in accordance with the invention.

Optionally, the device 1 also comprises the means 7 for rotating the first geometric-phase lens L₁ and the second geometric-phase lens L₂. The rotational means 7 is adapted to simultaneously incline the first geometric-phase lens L₁ and the second geometric-phase lens L₂ so that the first optical axis Z₁ forms an angle θ with respect to the axis of propagation of the incident light beam 100. The rotational means 7 holds the first geometric-phase lens L₁ and the second geometric-phase lens L₂ parallel to one another during their simultaneous rotation.

According to this second embodiment, the offset introduced between the first optical center O₁ and the second optical center O₂ may be obtained only by the joint inclination of the first geometric-phase lens L₁ and the second geometric-phase lens L₂. In the example illustrated in FIG. 3, the first optical axis Z₁ and the second optical axis Z₂ are coincident. The first geometric-phase lens L₁ and the second geometric-phase lens L₂ are simultaneously inclined, for example via the rotational means 7, so as to introduce an angle of inclination θ₁ between the axis of propagation of the incident light beam 100 and the first optical axis Z₁ (which is herein coincident with the second optical axis Z₂). Hence, the direction of propagation of the incident light beam 100 is inclined with respect to the first optical axis Z₁ and to the second optical axis Z₂ by the angle of inclination θ₁. The angle of inclination θ₁ is comprised between 0 and 90 degrees (that is to say between 0 and 1.57 radians), preferably smaller than 20 degrees (in the case of a small angle of inclination).

The second optical center O₂ is offset by a second distance e with respect to the projection P₁ of the first optical center O₁ on the second geometric-phase lens L₂ according to the first optical axis Z₁, transversely to an axis Z as defined by the orthonormal reference frame XYZ.

In this case, the offset introduced by the joint rotation of the first geometric-phase lens L₁ and the second geometric-phase lens L₂, corresponding to the projection P₁ of the first optical center O₁ according to the first optical axis Z₁ on the second geometric-phase lens L₂, is equal to D·tan(01). And finally, the separation angle δ is given by the following approximate relationship:

$$δ = \frac{2 D \cdot tan ( {θ}_{1} )}{F} \qquad [ Math . 2 ]$$

For a first distance D in the range of 3 mm and a small value of the angle of inclination θ₁ (in the range of a few degrees, in practice smaller than 20 degrees), the angular separation law δ/O₁ is in the range of 0.12.

In this example, the separation plane of the right circular polarization and of the left circular polarization of the incident light beam 100 is parallel to the axis of propagation of the incident light beam 100 and to the line connecting to the first optical center O₁ and the second optical center O₂.

Alternatively, the offset introduced between the first optical center O₁ and the second optical center O₂ may be obtained by a combination of a transverse offset as introduced before and of the joint inclination of the first geometric-phase lens L₁ and of the second geometric-phase lens L₂ with respect to the incident light beam 100. The first geometric-phase lens L₁ and the second geometric-phase lens L₂ are simultaneously inclined by the rotational means 7 so as to introduce an angle of inclination θ₁ between the axis of propagation of the incident light beam 100 and the first optical axis Z₁. Since the first optical axis Z₁ and the second optical axis Z₂ are parallel, the same angle θ₁ is observed between the axis of propagation of the incident light beam 100 and the second optical axis Z₂. The angle of inclination θ₁ is comprised between 0 and 90° (that is to say between 0 and 1.57 radians), preferably smaller than 20° (in the case of a small angle of inclination).

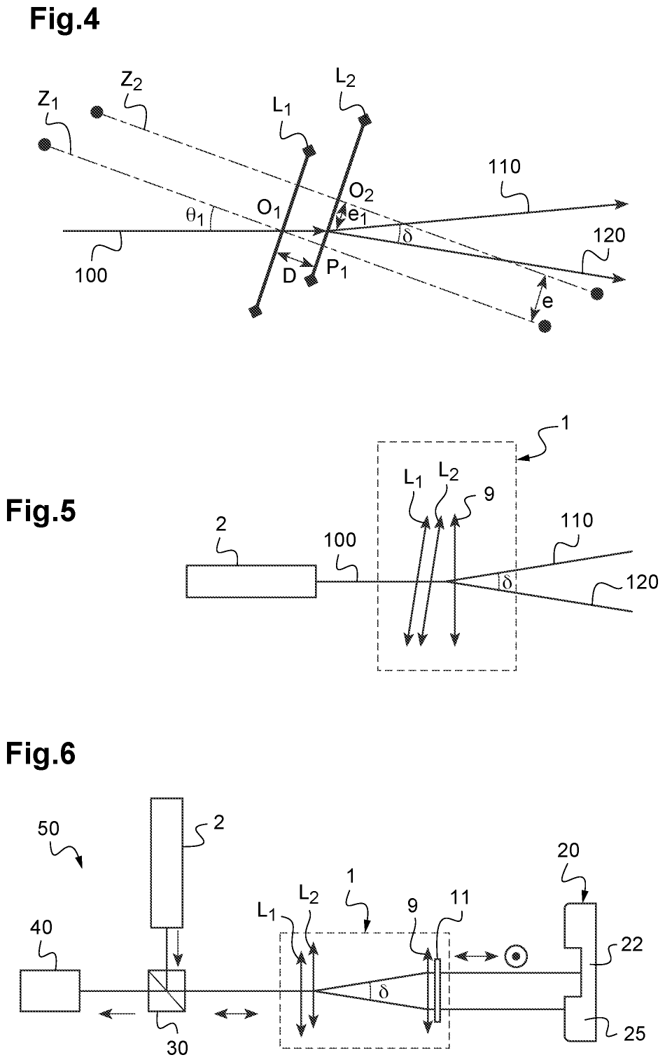

FIG. 4 represents this variant of the polarization separation device 1 in accordance with the invention. It corresponds to a variant of the first embodiment wherein the set formed by the first geometric-phase lens L₁ and the second geometric-phase lens L₂ is inclined. In other words, the first geometric-phase lens L₁ and the second geometric-phase lens L₂ are offset by the second distance e₁ in a direction transverse to the axis of propagation of the incident light beam 100 and then inclined for example by the rotational means 7 so that the axis of propagation of the incident light beam 100 and the first optical axis Z₁ form another angle of inclination θ₂. Hence, the direction of propagation of the incident light beam 100 is inclined with respect to the first optical axis Z₁ and to the second optical axis Z₂ by the other angle of inclination θ₂. In practice, the angle of inclination θ₂ is smaller than 20°.

In this case, the offset between the projection P₁ of the first optical center O₁ and the second optical center O₂ introduced by the joint rotation of the first geometric-phase lens L₁ and the second geometric-phase lens L₂ is equal to D·tan(θ₂). And finally, the separation angle δ between the first polarized light beam 110 and the second polarized light beam 120 is given by the relationship:

$$δ = \frac{2 ( {e}_{1} + D \cdot tan ( {θ}_{2} ) )}{F} \qquad [ Math . 3 ]$$

The second distance e₁ may be fixed by construction. Advantageously, this variant allows introducing, at a lesser cost, an adjustable offset between the first geometric-phase lens L₁ and the second geometric-phase lens L₂ in a transverse direction thanks to the joint inclination of the first geometric-phase lens L₁ and the second geometric-phase lens L₂.

As set out before and represented in FIG. 5, the device 1 may optionally comprise a lens 9. This lens 9 is adapted to compensate for a defocusing phenomenon originating from the longitudinal distancing, quantified by the first distance D, between the first geometric-phase lens L₁ and the second geometric-phase lens L₂. This lens 9 then allows ensuring that the polarized light beams are also collimated, that it is to say which infinite radii of curvature. The lens 9 is selected so as to limit the introduction of aberrations at the output of the device 1. For example, the lens 9 is a divergent conventional lens.

Indeed, the first distance D between the first geometric-phase lens L₁ and the second geometric-phase lens L₂ may be at the origin of a defocusing between the first polarized light beam 110 and the second polarized light beam 120.

The relative defocusing Δ between the two polarized light beams depends on the radii of curvature associated to each polarization and is expressed as the deviation between the two corresponding optical powers.

In practice, as regards the right circular polarization component of the incident light beam 100 (emitted for example by a source 2 represented in FIG. 5), the associated radius of curvature is given by the relationship:

$${R}_{1} = \frac{F ( D - F )}{D} \qquad [ Math . 4 ]$$

As regards the left circular polarization component of the incident light beam 100, the associated radius of curvature is given by the relationship:

$${R}_{2} = \frac{- F ( D + F )}{D} \qquad [ Math . 5 ]$$

Thus, the relative defocusing Δ possibly to be compensated for is given by the following relationship:

$$Δ = \frac{1}{{R}_{1}} - \frac{1}{{R}_{2}} = \frac{2 {D}^{2}}{F ( {D}^{2} - {F}^{2} )} \qquad [ Math . 6 ]$$

The focal length of the lens 9 is determined so as to reduce the determined relative defocusing Δ. Herein, the lens 9 has no effect on the polarization of the polarized light beams and on the angular separation δ.

For example, for a focal length of the geometric-phase lenses equal to F=50 mm and a longitudinal distance between the two geometric-phase lenses equal to D=3 mm, the radii of curvature associated to the two polarizations are in the range of: R₁=−783 mm and R₂=−883 mm. The associated relative defocusing Δ is in the range of: Δ=0.146 diopter. For example, a divergent lens 9 with a focal length f=−1000 mm is positioned, at the output, against the second geometric-phase lens L₂. The corrected radii of curvature are then estimated as: R₁=−3608 mm and R₂=−7547 mm.

Alternatively, it is possible to determine the value of the first distance D so as to compensate for the relative defocusing Δ. For this purpose, a value of the average radius of curvature Rₐᵥ may be fixed beforehand. This fixed value is selected so as to be able to be compensated by a selected lens. The average radius of curvature is given by the relationship:

$${R}_{av} = \frac{{R}_{1} + {R}_{2}}{2} = \frac{- {F}^{2}}{D} \qquad [ Math . 7 ]$$

The first distance D is determined from the fixed value for the average radius of curvature Rₐᵥ. For example, for a value of the average radius of curvature Rₐᵥ fixed at Rₐᵥ=1000 mm and a focal length of the geometric-phase lenses equal to F=50 mm, the obtained first distance D is equal to D=2.5 mm. The radii of curvature associated to the two polarizations are then equal to: R₁=950 mm and R₂=1050 mm. A divergent lens 9 with a focal length equal to f=−1000 mm is introduced and the modified radii of curvature are equal to: R₁=−19000 mm and R₂=21000 mm then allowing reducing the relative defocusing Δ).

The polarization separation device 2 may also optionally comprise the quarter-wave delay plate 11. The quarter-wave delay plate is positioned at the output of the second geometric-phase lens L₂. The quarter-wave delay plate 11 allows transforming the orthogonal circular polarizations into orthogonal linear polarizations. Thus, a polarization separation device is obtained which angularly separates an incident light beam into two light beams with orthogonal linear polarizations. Thus, the combination of two geometric-phase lenses and of a quarter-wave delay plate allows replicating, in form of a thin device, the function of a Wollaston prism.

In an application to differential interferometry, the quarter-wave delay plate enables a recombination of the polarized light beams for example in the case of a reflection of these beams on a surface to be studied.

This is the case in particular when the polarization separation device 1 is integrated in a differential interferometry system (FIGS. 6 and 7). This technique allows measuring the relative variation of two optical pathways. For example, in the case of a supervision of plasma etching or erosion of a surface 20, one of the polarized light beams is reflected by an eroded area 22 and the other polarized light beam is reflected by a protected area 25 of the plasma.

In this case, the device 1 serves as a combiner of the reflected beams and so that these are not separated again by the device 1, the quarter-wave delay plate 11 allows inverting the polarizations between the forward direction and the backward direction.

According to a first example of a differential interferometry system 50 represented in FIG. 6, the device 1 is made according to the previously-described first embodiment. The differential interferometry system 50 comprises a light source 2, a (non-polarizing) separation device 30 and a detection unit 40. These elements are compliant with those conventionally used and are not herein described in details.

In the device 1, the quarter-wave delay plate 11 is for example positioned after a lens 9 for compensating for the defocusing. The quarter-wave plate 11 then enables a conversion into linear polarizations of the incident beams and a conversion into circular polarizations of the reflected beams.

According to a second example of a differential interferometry system 52 represented in FIG. 7, the device 1 is made according to the second embodiment wherein no transverse offset of the geometric-phase lenses is observed, only the joint rotation of the two geometric-phase lenses allows obtaining an offset between the first optical center O₁ and the second optical center O₂.

Still alternatively (not represented), a differential interferometry system may comprise a polarization separation device 1 as represented in FIG. 4.

FIG. 8 represented another embodiment of the polarization separation device 1 in accordance with the invention. According to this other embodiment, the device 1 comprises two pairs of geometric-phase lenses: on the one hand, the first geometric-phase lens L₁ and the second geometric-phase lens L₂ and, on the other hand, a third geometric-phase lens L₃ and a fourth geometric-phase lens L₄. The geometric-phase lenses L₁, L₂, L₃ and L₄ are positioned in series on the axis of propagation of the incident light beam 100 with a fifth distance S₁ between the second geometric-phase lens L₂ and the third geometric-phase lens L₃.

For example, the third geometric-phase lens L₃ has a third optical center O₃, a third optical axis Z₃ and a third focal length F₃. The fourth geometric-phase lens L₄ has a fourth optical center O₄, a fourth optical axis Z₄ and a fourth focal length F₄. Preferably, the third focal length F₃ and the fourth focal length F₄ are equal to the focal length F (like the first focal length F₁ and the second focal length F₂). Alternatively, the third focal length F₃ and the fourth focal length F₄ may be equal to another focal length F_{A}, different from the focal length F (to which the first focal length F₁ and the second focal length F₂ are equal). The device also operates if the third focal length F₃ and the fourth focal length F₄ may be different from one another but still close, for example with a deviation less than or equal to 10%.

Herein, the third geometric-phase lens L₃ and the fourth geometric-phase lens L₄ have a spherical optical power. The third geometric-phase lens L₃ and the fourth geometric-phase lens L₄ are directed so that each is convergent for one circular polarization and divergent for the other circular polarization. In this case, the third geometric-phase lens L₃ and the fourth geometric-phase lens L₄ respectively focus at the focal points F₃ and −F₃ on the third optical axis Z₃ and at the focal points F₄ and −F₄ on the fourth optical axis Z₄. Alternatively, the third geometric-phase lens L₃ and the fourth geometric-phase lens L₄ have a cylindrical optical power, while being convergent for one circular polarization and divergent for the other circular polarization. In the case of lenses having a cylindrical optical power, for example in the case where the third geometric-phase lens L₃ has a cylindrical optical power, a collimated incident light beam with an axis parallel to the third optical axis Z₃ is focused according to a line segment orthogonal to the third optical axis Z₃ passing through the focal point F₃ for a circular polarization and according to another line segment orthogonal to the third optical axis Z₃ passing through the focal point −F₃ for the other circular polarization. Whether they have a spherical or cylindrical optical power, these geometric-phase lenses can be corrected for different geometric aberrations, in the same manner as spherical or cylindrical conventional lenses could be while being referred to as aspherical or acylindrical lens.

The third geometric-phase lens L₃ and the fourth geometric-phase lens L₄ are positioned in the same direction. For example, the third geometric-phase lens L₃ and the fourth geometric-phase lens L₄ are positioned in the same direction as the first geometric-phase lens L₁ and the second geometric-phase lens L₂. Alternatively, the third geometric-phase lens L₃ and the fourth geometric-phase lens L₄ may be positioned in a direction opposite to the first geometric-phase lens L₁ and the second geometric-phase lens L₂.

In general, the third optical axis Z₃ and the fourth optical axis Z₄ form an angle smaller than a few degrees. In the following, the third optical axis Z₃ and the fourth optical axis Z₄ are parallel. Alternatively, the third optical axis Z₃ and the fourth optical axis Z₄ are coincident.

The third geometric-phase lens L₃ and the fourth geometric-phase lens L₄ are in contact or separated from one another by a third distance D′ according to the first optical axis Z₁. In practice, this third distance D′ is smaller than the third focal length F₃ and the fourth focal length F₄. The third distance D′ is smaller than 20% of the third focal length F₃ and of the fourth focal length F₄. Preferably, the third distance D′ is for example smaller than 10% of the third focal length F₃ and of the fourth focal length F₄. In other words, the third distance D′ is as small as possible. In the case where the third focal length F₃ and the fourth focal length F₄ are equal to the focal length F, the third distance D′ is smaller than the focal length F.

Herein, the third geometric-phase lens L₃ and the fourth geometric-phase lens L₄ are placed proximate to one another (the third distance D′ between the third geometric-phase lens L₃ and the fourth geometric-phase lens L₄ is therefore small in comparison with the focal length F). For example, the third distance D′ is in the range of 3 mm.

According to this third embodiment, the fourth optical center O₄ is offset by a non-zero fourth distance e′ with respect to the first optical axis Z₁ in a direction transverse to the axis of propagation of the incident light beam 100. In practice, herein, the device 1 comprises for example another translational means between the third phase lens L₃ and the fourth geometric-phase lens L₄. The fourth distance e′ is comprised between 100 μm and a few millimeters. By construction, a projection P₃ of the third optical center O₃ according to the third optical axis Z₃ on the fourth geometric-phase lens L₄ is located at the fourth distance e′ from the fourth optical center O₄.

The other translational means is adapted to offset the fourth optical center O₄ by the fourth distance e′ with respect to the third optical center O₃ according to a direction transverse to the first optical axis Z₁. In practice, the other translational means is therefore adapted to offset the fourth geometric-phase lens L₄ by the fourth distance e′ according to a direction transverse to the first optical axis Z₁. In practice, the segment P₁O₂ is contained within a plane XY orthogonal to the axis Z and the segment P₃O₄ is contained within another plane XY orthogonal to the axis Z. By construction, the segment P₁O₂ has a direction opposite to the segment P₃O₄.

As shown for example in FIG. 8, thanks to this other translational means, the fourth optical axis Z₄ is offset by the fourth distance e′ with respect to the third optical axis Z₃. Another offset direction of the fourth optical axis Z₄ with respect to the third optical axis Z₃ is defined from the position of the fourth optical center O₄ with respect to the first optical axis Z₁. For example, the other offset direction is defined from the position of the fourth optical center O₄ in a plane XY with respect to the third optical axis Z₃. Alternatively, the other offset direction may be defined from the position of the fourth optical center O₄ with respect to the axis of propagation of the incident light beam 100.

As shown in FIG. 8, the first pair of geometric-phase lenses (L₁, L₂) is separated from the second pair of geometric-phase lenses (L₃, L₄) by the fifth distance S₁. In practice, the first optical center O₁ and the fourth optical center O₄ are separated by the fifth distance S₁.

As shown in FIG. 8, advantageously according to the invention, the incident light beam 100 is first separated angularly and in polarization into the first polarized light beam 110 and the second polarized light beam 120. Advantageously according to the invention, the first polarized light beam 110 and the second polarized light beam 120 have orthogonal circular polarizations. A first separation angle δ₁ is defined between the first polarized light beam 110 and the second polarized light beam 120 which are collimated. Then, the first polarized light beam 110 is, in turn, diverted by a second separation angle δ₂ to form a third polarized light beam 114. The first polarized light beam 110 and the third polarized light beam 114 have the same polarization. The second separation angle δ₂ is defined between the first polarized light beam 110 and the third polarized light beam 114.

Symmetrically, the second polarized light beam 120 is, in turn, diverted by the second separation angle δ₂/2 to form a fourth polarized light beam 122. The fourth polarized light beam 122 and the second polarized light beam 120 have the same polarization. Similarly, the second separation angle δ₂/2 separates the fourth polarized light beam 122 and the second polarized light beam 120.

The total angular separation δ₃ at the output of the device 1 illustrated in FIG. 8 is then equal to: δ₃=δ₁+δ₂.

As shown in FIG. 8, the axes of the third polarized light beam 114 and of the fourth polarized light beam 122 intersect at the output of the device 1 at a sixth distance S₂ from the fourth optical center O₄ at a point I. The sixth distance S₂ is given by the relationship:

$${S}_{2} = \frac{{δ}_{1}}{{δ}_{2}} {S}_{1} = \frac{2 e / F}{2 {e}^{′} / F} {S}_{1} = \frac{e}{{e}^{′}} {S}_{1} \qquad [ Math . 8 ]$$

Hence, the distance at which the axes of the third polarized light beam 114 and of the fourth polarized light beam 122 intersect depends on the transverse offset between the first and second geometric-phase lenses on the one hand, on the transverse offset between the third and fourth geometric-phase lenses, on the other hand, and on the fifth distance S₁ separating the two pairs of geometric-phase lenses.

Advantageously, this third embodiment may be used in the context of differential contrast optical microscopy. This technique is used to highlight low heterogeneities. For this purpose, besides angularly separating the incident light beam, it is also interesting to make sure that the two separated polarized light beams intersect outside the separation device. Such a known device is based on Nomarski prisms. In comparison with this known device, the third embodiment of the polarization separation device 1 according to the invention is more compact. In addition, it has the advantage of enabling an adjustment of the separation angle of the polarized beams as well as of the position of intersection of the output beams. It also allows preserving the quality of the differential contrast mode when the objective of the microscope is changed or when a variable magnification objective is used. Finally, since only one type of geometric-phase lenses is used to achieve a plurality of separation angles and of intersection positions, the production is simplified.

Alternatively, the device 1 may comprise a portion of the geometric-phase lens L₁ and a portion of the geometric-phase lens L₂. In this case, the portions of the geometric-phase lenses operate like a Fresnel lens.

1. A polarization separation device intended to receive an incident light beam, the device comprising a first geometric-phase lens, having a first optical center, a first optical axis and a positive first focal length for a first circular polarization state and an opposite focal length for another circular polarization state orthogonal to the first circular polarization state, and a second geometric-phase lens, having a second optical center, a second optical axis and a positive second focal length for the first circular polarization state and an opposite focal length for the other circular polarization state, the first optical axis and the second optical axis forming an angle smaller than a few degrees, the first and second geometric-phase lenses being separated from one another by a first distance according to the first optical axis,
the device being configured and directed so that a projection of the first optical center according to the first optical axis on the second geometric-phase optical lens is located at a non-zero second distance from the second optical center, said first distance being smaller than said first focal length and said second focal length.

2. The polarization separation device according to claim 1, wherein the first focal length and the second focal length have a difference less than or equal to 10%.

3. The polarization separation device according to claim 1, wherein the second optical axis is offset by the second distance with respect to the first optical axis.

4. The polarization separation device according to claim 3, comprising a translational means between the first and second geometric-phase lenses, said translational means being adapted to offset the second optical center with respect to the first optical center according to a direction transverse to the first optical axis.

5. The polarization separation device according to claim 1, wherein the first optical axis forms an angle with respect to an axis of propagation of the incident light beam on said device.

6. The polarization separation device according to claim 5, comprising a means for rotating the first and second geometric-phase lenses, the first geometric-phase lens and the second geometric-phase lens being held parallel to one another, said rotational means being adapted to simultaneously incline said first and second geometric-phase lenses with respect to the incident light beam.

7. The polarization separation device according to claim 1, wherein the first distance is smaller than 20% of the first focal length and of the second focal length.

8. The polarization separation device according to claim 1, wherein the first geometric-phase lens and the second geometric-phase lens have a spherical or cylindrical optical power.

9. The polarization separation device according to claim 1, comprising a divergent optical lens.

10. The polarization separation device according to claim 1, comprising a quarter-wave delay plate.

11. The polarization separation device according to claim 1, comprising a third geometric-phase lens, having a third optical center, a third optical axis and a third focal length, and a fourth geometric-phase lens, having a fourth optical center, a fourth optical axis and a fourth focal length, the third geometric-phase lens and the fourth geometric-phase lens being disposed so as to have an optical power with the same sign for the first circular polarization state and with an opposite sign for the other orthogonal circular polarization state, the third optical axis and the fourth optical axis forming an angle smaller than a few degrees with the first optical axis, the third and fourth geometric-phase lenses being separated from one another by a third distance according to the third optical axis, a projection of the third optical center according to the third optical axis on the fourth geometric-phase lens being located at a non-zero fourth distance from the fourth optical center, said third distance being smaller than said third focal length and said fourth focal length.

12. A differential interferometer comprising a polarization separation device according to claim 1.

13. A differential contrast optical microscope comprising a polarization separation device according to claim 1.

14. The polarization separation device according to claim 2, wherein the second optical axis is offset by the second distance with respect to the first optical axis.

15. A differential interferometer comprising the polarization separation device according to claim 4.

16. A differential interferometer comprising the polarization separation device according to claim 6.

17. A differential interferometer comprising the polarization separation device according to claim 8.

18. A differential contrast optical microscope comprising the polarization separation device according to claim 4.

19. A differential contrast optical microscope comprising the polarization separation device according to claim 6.

20. A differential contrast optical microscope comprising the polarization separation device according to claim 8.
